(19) United States
(12) Patent Application Publication
(10) Pub. No.: US 2002/0070533 A1
(43) Pub. Date: Jun. 13, 2002

(54) Foldable rollator with transport feature

(76) Inventor: John Owens, Sheffield Village, OH (US)

Correspondence Address: Daniel J. Hudak, Hudak & Shunk Co., L.P.A., Suite 808, 7 West Bowery Street, Akron, OH, 44308, US

(21) Appl. No.: 09/965,924

(22) Filed: Sep. 28, 2001

Related U.S. Application Data
(60) Provisional application No. 60/237,810, filed on Oct. 4, 2000.

(51) Int. Cl. B62B 3/00

(52) U.S. Cl. 280/650; 280/647

(57) ABSTRACT

A rollator is provided which has a modified frame with offset wheels and upright armor handle posts which extend into handles. Further, the rollator has a flip-up seat and a push member to allow an attendant to push a person seated on the seat. The rollator has hand brakes mounted on the handles and an optional front basket and foot rests.

THIS PATENT APPLICATION IS BASED UPON U.S. PROVISIONAL APPLICATION SER. NO. 60/237,810, FILED Oct. 4, 2001

The invention relates generally to wheeled ambulatory supports, or rollators, and more particularly to a foldable rotatory which is designed to allow transport of the user using the device.

### BACKGROUND OF THE INVENTION

Certain health conditions hinder vertical balance and other mechanics of walking. The health care industry has developed aids for those who suffer from such conditions, including crutches, walkers, rollers, and wheelchairs. Rollators are wheeled supports which aid individuals who have function in their lower limbs, but lack the strength or balance to enable them to walk unsupported. Generally, these supports include two sets of wheels in order to avoid the need to lift the device as is the case for walkers. Further, these devices usually include a seat so that a user may use the device to sit and rest.

Prior art rollators have a frame that forms a enclosure about the user. The enclosure is open to the back and the user leans toward the closed front portion of the frame. These frames are usually U-shaped or A-shaped. If the rollator includes a seat, the user turns to face the open side and seat facing the opposite direction from the orientation when the rollator is in active use.

### SUMMARY OF THE INVENTION

The present invention has a modified frame which provides for seated transport of a user. In particular, the frame is a modified A-frame which has offset wheels in a wider wheelbase for balance, and a more vertical arm or handle posts that provides a better position for pushing a user when seated in the rollator. Two embodiments are provided. In the first embodiment, the rollator has a back handle that can be used as a push bar. In a second embodiment, the walking handles can be rotated in the handle post in order to provided for a means for an attendant to push a seated user from the rear. Further, the rollator has small, unobtrusive feet rest members which are mounted on the rear wheels in order to allow the user a position to rest his feet if the device is used for transport. These feet rest members can also be used to tilt the device for curb climbing. The device has a seat which can be positioned at a number of seat heights and flips up, a reversible basket which can be loaded from under the seat, or from the front, and the device can be folded for more compact storage. The device has front and rear castor forks. The backrest or back strap can be reversed to accommodate ambulation or transport.

### BRIEF DESCRIPTION OF THE DRAWINGS

FIG. 1 is a front perspective of a first embodiment of the rollator in accordance with the present invention;

FIG. 2 is a front perspective of the rollator shown in FIG. 1 in a folded position;

FIG. 3 is a front view of the embodiment shown in FIG. 1;

FIG. 4 is a rear view showing the backrest and push handle assembly;

FIG. 5 is a right side view of the backrest and push handle assembly shown in FIG. 4;

FIG. 6 is a bottom view of the backrest and push handle assembly shown in FIG. 4; and

FIG. 7 is a top perspective of a second embodiment of the rollator frame in accordance with the invention.

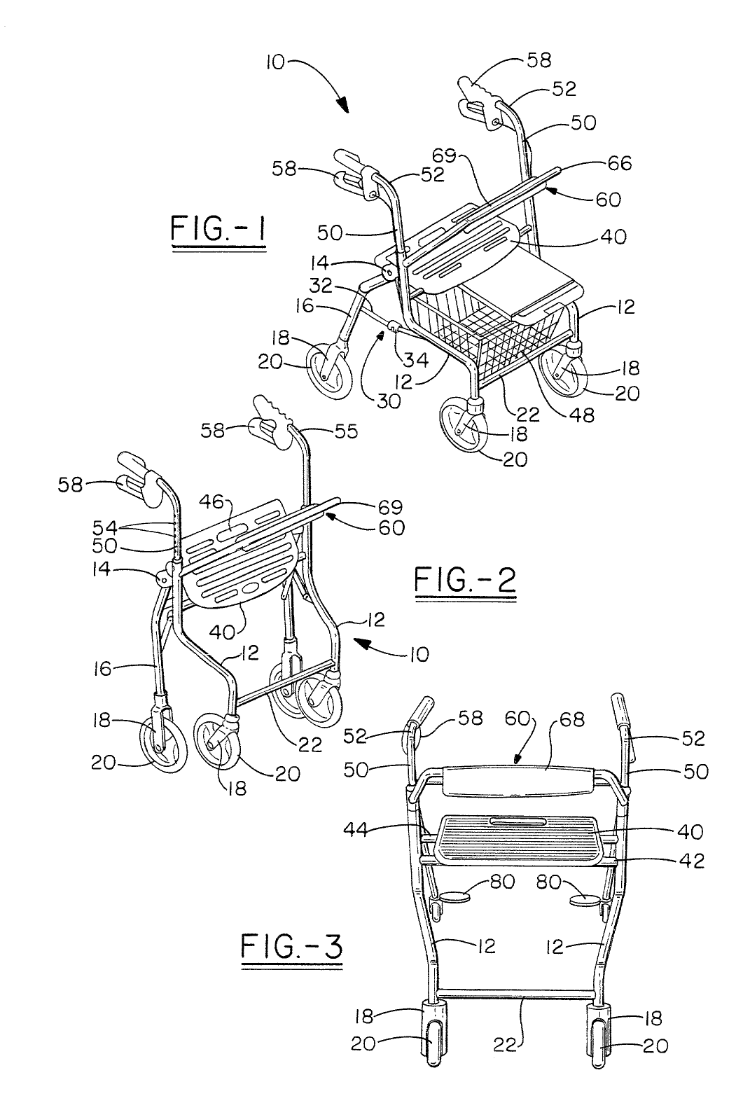

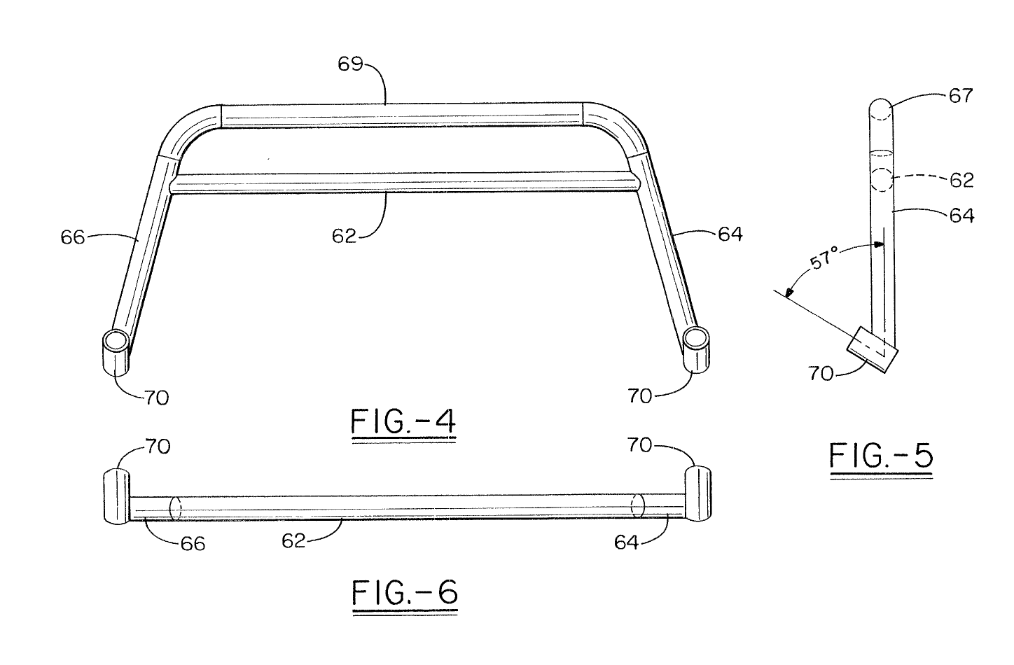

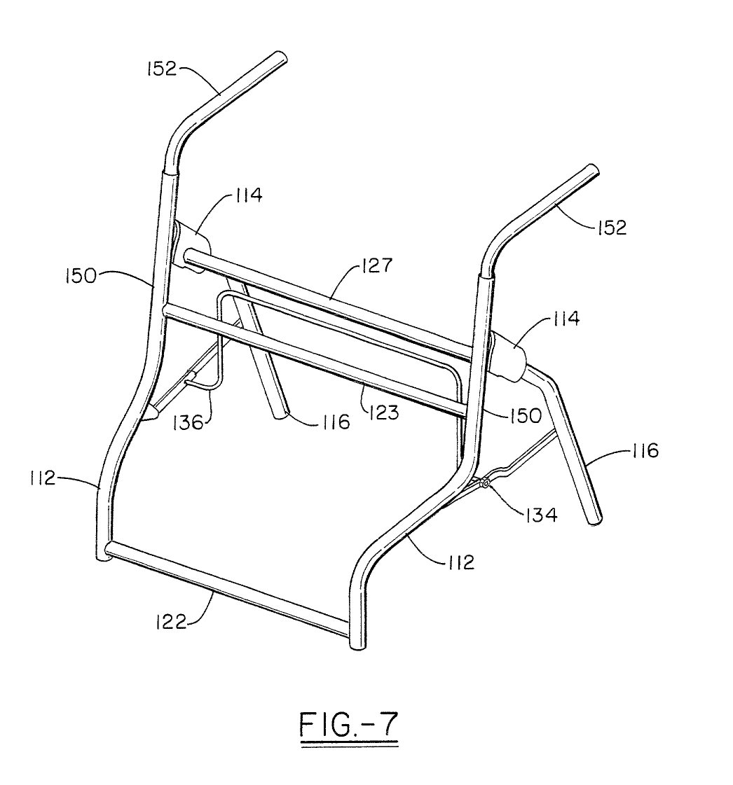

### DETAILED DESCRIPTION OF THE INVENTION

The wheeled ambulatory support, or rollator of the present invention has a foldable frame 10 having a pair of tubular lateral side supports 12 in the front, which extend downwardly from a hinged connection 14 with the pair of tubular lateral side supports 16 in the rear of the device. The references to front and rear relate to the device when it is open for use in walking, and with respect to the orientation of the patient user. These references remain the same even though a seated user will be seated in the opposite direction.

Each of the pairs of lateral side supports include forked wheel holders 18 which are supported on wheels 20. The front lateral side supports 12 also include a transverse link 22 to provide for further stability. The lateral side supports are offset laterally inward above the connection with the link 22 in order to provide for pass-by room with the rear set of wheels during folding, as can be seen in FIG. 2. The front set of forks are freely pivotable to provide a castor type wheel. The frame assembly also includes a release link assembly 30. This assembly 30 has a pair of side members 32 which are hinged in the middle 34 to allow the assembly to collapse. In the open position, these side members lock the frame into an open position. A release bar 136 can be seen in the embodiment shown in FIG. 7 in order to fold the side member of that embodiment about the pivot 134 to allow the frame to be folded when the release bar is pulled upward.

A seat member 40 is pivotably mounted on a horizontal seat support member 42. The seat 40 further rests on a second seat support member 44. The seat includes a hand hold 46 which can be grasped to rotate the seat 40 about the seat support member 42 and pull the seat into the folded position. The seat can also be released from the seat support in order to access an optional basket 48 which can be mounted between the front and rear side supports 12, 16.

A pair of laterally spaced handle support posts, 50 extend upwardly from the front pair of lateral side support members 12. These support posts 50 are substantially vertical or angled slightly off vertical toward the rear. Handlebars 52 extend upward from the support posts 50 and can have a adjustable telescoping relationship in order to permit the adjustment of the height by raising of lowering the handlebars in the posts and than locking them into position by sliding a key into the aligned holes 54 shown in FIG. 2. The handlebars 52 also include hand grip members which are located on a substantially horizontally positioned portion 55 of the handlebars 52. The handlebars 52 also include brake members 58. The handlebars 52 are positioned so that the can act both as push bars for an ambulatory user, and also can be position to allow the user to rest their arms on the horizontal portion 55 during transport.

The rollator also includes a backrest assembly 60 which has a lower transverse backrest member 62 supported between the spaced side members 64of a U-shaped frame 66. The backrest member 62 includes a tubular pad 68 to make the backrest more comfortable for the seated user. The top transverse member 69 of the U-shaped frame 66 is joined to support posts by a pair of tubular elbow joints 70, which form an angle of 57 degrees to the side members. The top transverse member is used as a push bar by an attendant when the device is used for transport.

The rear wheels each include small U-shaped supports 80 which extend a few inches into the open space of the rollator. These supports 80 can be used to tilt the rollator for curb climbing, and also to accommodate the feet of the user during transport.

A second embodiment of the invention is shown in FIG. 7. This drawing shows a modified A-frame assembly having a front pair of side supports 112, and a rear pair of side supports 116 joined at a hinged connection 114. The front supports 112 include two transverse links 122, 123. The rear side supports also include a transverse link 127. Once again, the frame includes a pair of substantially upright support posts 150 which have height adjustable telescoping handlebars 152. These handlebars can be rotated 180 degrees in order to allow for pushing of the rollator for transport.

While in accordance with the patent statutes the best mode and preferred embodiment have been set forth, the scope of the invention is not limited thereto, but rather by the scope of the attached claims.

What is claimed is:

1. A rollator having a transport function comprising:
a frame having a pair of spaced front legs each including a wheel and a pair of spaced rear legs each including a wheel, the front legs and the rear legs being pivotable joined together to provide for folding of the rollator, and the frame further including a pair of spaced upwardly extending posts which have a rearward facing push member, the frame supporting a horizontal seat member.

2. A rollator as set forth in claim 1, wherein the rear wheels each include a foot rest which extends toward the lateral centerline of the rollator.

3. A rollator as set forth in claim 1, wherein said upwardly extending posts further each include a substantially horizontally extending terminal hand support area.

4. A rollator as set forth in claim 3, wherein said hand support area includes a hand grip.

5. A rollator as set forth in claim 4, wherein at lest one of said hand support area further includes a braking member for said rollator.

6. A rollator as set forth in claim 1, wherein said push member comprises a member which extends in a horizontal direction substantially parallel to a plane defined by said pair of upwardly extending posts.

7. A rollator as set forth in claim 6, wherein said transverse member comprises a U-shaped bar having opposing side members, each supported on one of said pair of spaced upwardly extending posts.

8. A rollator as set forth in claim 1, wherein said spaced front wheels each include pivotable castor wheels.

9. A rollator as set forth in claim 1, wherein said rearward facing push member is connected to said frame to form a back support when a person is seated in said horizontal seat member.

10. A rollator having a transport function comprising;
a frame having a pair of spaced front legs, each including a pivotable castor wheel, and
a pair of spaced rear legs, each including a wheel, the front legs and the rear legs being pivotally joined together to provide for folding of the rollator; and
said frame further including a pair of spaced upwardly extending posts terminating in a pair of spaced handles located substantially upward of said spaced rear wheels, the frame supporting a horizontal seat member and further including a rearward facing push member.

11. A rollator as set forth in claim 10, wherein said horizontal seat member is pivotally attached to said frame.

12. A rollator as set forth in claim 10, wherein handles each include a brake member.

13. A rollator as set forth in claim 10, wherein said rearward facing push member comprises a horizontal support extending in the space between said upwardly extending posts parallel to a plane defined by said posts.

14. A rollator as set forth in claim 13, wherein said push member serves as a backrest member for said horizontal seat member when a person is seated on said seat.

15. A rollator as set forth in claim 10, further including a basket member supported in the space formed between said front legs and said rear legs.

16. A rollator as set forth in claim 10, wherein said upwardly extending posts are substantially vertical.

17. A rollator as set forth in claim 10, further including a pair of side members for each side which extend between the front leg and the rear leg for each lateral side which extend between the front leg and the rear leg and including a pull member which initiates folding of the rollator.
